(19) United States
(12) Patent Application Publication
(10) Pub. No.: US 2011/0030307 A1
(43) Pub. Date: Feb. 10, 2011

(54) CONCRETE BAR SLAG CONTAINER

(75) Inventors: Ricardo A. Rodriguez, Monterry (MX); Milton Hernandez Gomez, Monterrey (MX)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/538,464

(22) Filed: Aug. 10, 2009

(51) Int. Cl. E04B 1/00; E04B 5/10; E04C 3/293; B23K 9/013

(52) U.S. Cl. 52/741.1; 52/633; 52/831; 219/121.39

(57) ABSTRACT

The present disclosure is directed to a containerization support structure for use in metal cutting including a flooring structure and a plurality of concrete composite structural bars positioned within the flooring structure. In another aspect of the present disclosure, a method of implementing a reusable containerization system for collecting metal by-product during a metal cutting operation includes the steps of positioning concrete composite structural bars within a flooring structure, where the flooring structure includes a plurality of longitudinally extending metal carriers positioned to house the bars; performing a metal cutting operation; collecting the metal by-product on the concrete composite structural bars; removing the bars; cleaning metal by-product from the bars; and returning the concrete composite structural bars to the metal carriers.

### TECHNICAL FIELD

The present disclosure relates generally to a container system, and more particularly to a containerization flooring system for use with laser or plasma cutting machines.

### BACKGROUND

Machining operations of various configured metal workpieces are a standard throughout the world, and are especially common with vehicular components. These operations include boring drilling, cutting or other metal manipulation operations executed with various types of cutting tools. Plasma cutting is a process that is used to cut steel and other metals of different thicknesses (and sometimes other maters) using a plasma torch. Traditionally, in this process, an inert gas (or compressed air) is blown at a high speed out of a nozzle, while at the same time an electrical arc is formed through that gas from the nozzle to the surface being cut, turning some of that gas into plasma. Since plasma cutters produce a very hot and very localized “cone” to cut with, they are extremely useful for cutting sheet metal in curved or angled shapes. The plasma is sufficiently hot to melt the metal being cut and moves sufficiently fast to blow molten metal away from the cut.

Plasma cutters have also been used in CNC (Computer Numerically Controlled) machinery. Movement of the cutting head is coordinated with movement of the machine to define a precise path on the part. The cutting head and laser or plasma arc are controlled to pierce and cut the workpiece to form holes and shapes in the material, then to cut the part from the material. Manufacturers build CNC cutting tables, some with the cutter built in the table. As the cutting machine process cuts and removes material at the extreme high temperatures, dross or slag builds up in the area below the cutting operation. Slag is a byproduct of steelmaking consisting of mixtures of metal oxides or sulfides. Dross is a mass of solid impurities floating on or in molten metal and appears usually upon the melting of low melting point metals or alloys such as tin, lead, zinc or aluminum or by oxidation for the metals. As is known in the art, scoria is the refuse, dross, or slag left after melting or smelting metal or scum, and will be used heretofore to describe the offal or byproduct in this disclosure.

Various means for collecting and removing scoria scrap from cutting machines have been utilized. One version is to allow the scrap to accumulate on the floor or on a platform or bed disposed below the cutting area. When the accumulation is excessive it is shoveled out. This method is low cost, but has disadvantages. The machine must be shut down while the scrap is removed, reducing productivity, and this method would not be feasible in large plant settings where the floor of the plasma cutting system must be walked on. Additionally, debris falling form the shovel can land on way covers or machine parts, where not wanted, leading to premature failures.

Another version may be to provide one or more scrap collecting pans under the cutting area to collect the scrap. This solution may be somewhat low cost, but it also has disadvantages. The machine is normally shut down while the scrap is removed, reducing productivity. If an excessive amount of scrap is allowed to accumulate, the pans are irreplaceably damaged and or very difficult to remove. The scrap pans may be large, numerous, and hard to handle. Further, this method may not be available for large-scale use, like in a factory or plant setting.

The industry standard is such that in large manufacturing facilities, the plasma cutting operations typically occur over a containerized flooring system with elongated metal slats typically vertically aligned and perpendicular to the floor, with open spacing between each slat for collecting the scoria by-product from the cutting machines. The scoria that falls from the cutting operation to the floor lands primarily on the metal slats, which melt and meld together with the hot scoria by-product that falls thereon, creating a non-removable, irreplaceable situation. Once the container is filled with melted metal slats and an inordinate amount of scoria build-up on the melted slats, the containers become un-operational and must be replaced. These containers are non-returnable, leading to excessive replacement costs for replacing each of flooring containers.

The present disclosure is directed to addressing and overcoming one or more of the problems and long felt need set forth above.

### SUMMARY OF THE INVENTION

The present disclosure is directed to a containerization support structure for use in metal cutting including a flooring structure and a plurality of concrete composite structural bars positioned within the flooring structure.

In another aspect of the present disclosure, a method of implementing a reusable containerization system for collecting metal by-product during a metal cutting operation includes the steps of positioning concrete composite structural bars within a flooring structure, where the flooring structure includes a plurality of longitudinally extending metal carriers positioned to house the bars; performing a metal cutting operation; collecting the metal by-product on the concrete composite structural bars; removing the bars; cleaning metal by-product from the bars; and returning the concrete composite structural bars to the metal carriers.

These and other aspects and advantages of the present disclosure will become apparent to those skilled in the art upon reading the following detailed description in connection with the drawings and appended claims.

### BRIEF DESCRIPTION OF THE DRAWINGS

FIG. 1 is a perspective view of an aspect of a containerization support structure in accordance with the present disclosure;

FIG. 2 is a perspective view of a bottom side of an aspect of a containerization support system of the present disclosure, showing a portion of a structural bar; and,

FIG. 3 is a perspective view of one embodiment of a containerization support system in accordance with the present disclosure.

### DETAILED DESCRIPTION

Reference will now be made in detail to embodiments for the present disclosure, examples of which are illustrated in the accompanying drawings. Wherever possible, the same reference numbers will be used throughout the drawings to refer to the same or like parts.

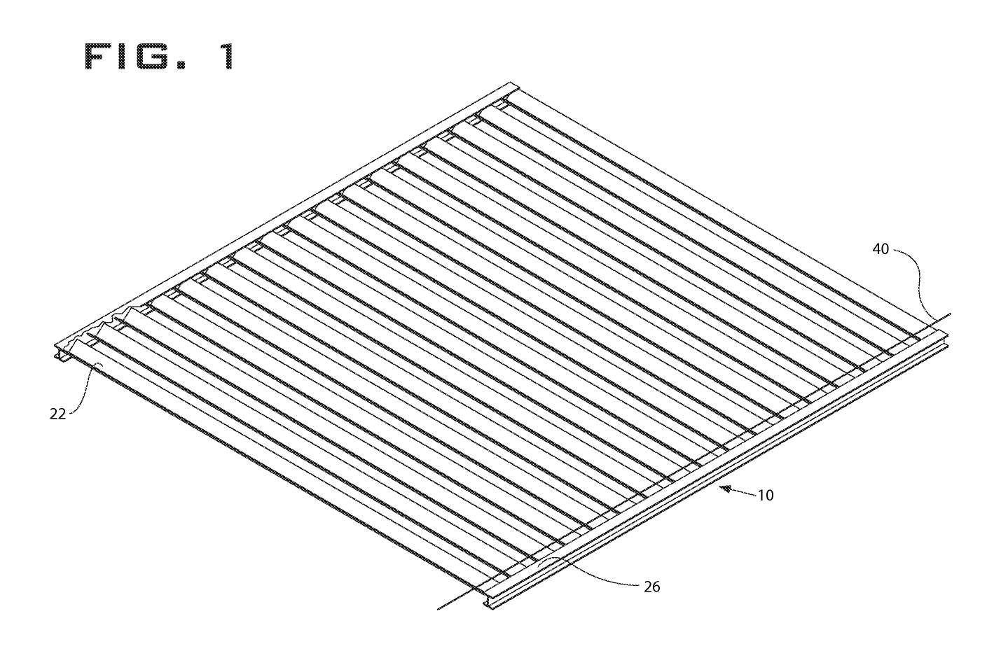

Referring particularly to FIG. 1, there is shown a containerization support system 10 of the present innovation for use with metal cutting processes. Metal cutting processes may include but are not limited to plasma arc and laser cutting.

Plasma and laser-equipped machine tools are often used to cut parts from sheet metal and relatively thick or thin plate. These machine tools are often Computer Numerically Controlled (CNC) and are manufactured in many configurations and sizes and with cutting torches of various types and power. Movement of the cutting head is coordinated with movement of the machine to define a precise path on the part. The cutting torches and laser or plasma arc are controlled to pierce and cut the workpiece to form holes and shapes in the material, then to cut the part from the material.

In the industry, remains of material from the cut may be called slag. Resolidified material clinging to the part may be called dross. As is known in the art, scoria 20 is the refuse, dross, or slag left after melting or smelting metal or scum, and will be used heretofore to describe the offal or byproduct in this disclosure. Scoria is a rough vesicular cinder-like material and generally has considerable structural strength, although light in weight. The term “scoria” has acquired various different meanings in the art, and is most commonly used to refer to the refuse or offal from metal cutting. For purposes of this application, the term “scoria” is used throughout, in both the specification and the claims, to mean “scoria” as hereinabove described and defined.

The present innovation eliminates or substantially alleviates the aforesaid disadvantages of the prior art by providing concrete composite structural bars which are light in weight, have entirely adequate structural strength for use in containerization flooring system for plasma cutting machines, and have a high degree of reusability to obviate the necessity of scrapping the entire flooring collection containers and starting from scratch. The structural concrete bars 12 of the present disclosure further exhibit entirely adequate resistance to heat.

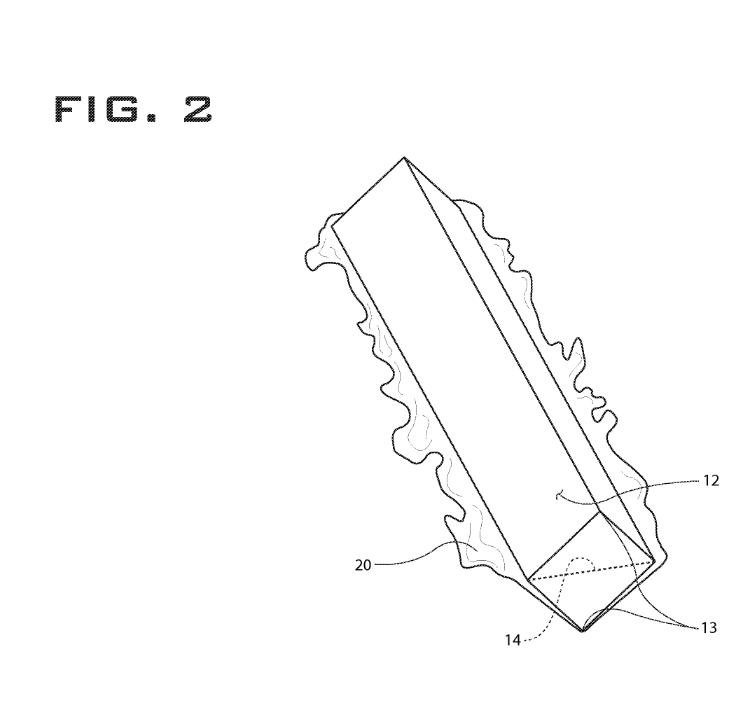

Turning momentarily to FIG. 2, of particular significance to the present disclosure is the structurally strong lightweight cementitious concrete comprising the bars 12. The bars 12 may often be disposed such that the peak 13, apex, or convex aspect of the bar (cross-sectionally 14) is at its highest point and maximum distance away from the flooring structure 40. This may aid in decreased build up of scoria 20 or metal by-product at one concentrated area on the bars 12. Accordingly it is desirable that this lightweight bar 12 be resistant to heat from the scoria 20 without compromise of its strength. It has been found that such a concrete can be constructed comprising scoria 20 as one aggregate therein to generally serving to impart strength, along with or in place of selected slag or dross as other aggregates generally providing similar strength properties.

Concretes comprising scoria aggregate generally exhibit strong structures. Scoria concretes, however, exhibit structural strengths typically in the range from about 1200 p.s.i. to about 3000 p.s.i., the range being at least marginally sufficient for these inventive structural uses.

The present state of the art in respect to economically achievable strengths of concretes includes several lightweight aggregates. Structural concrete typically comprises gravel, sand or the like, being hard, dense aggregates. Note that the lightweight aggregate scoria 20 can produce lightweight concretes of about 80 or 90 pounds per cubic foot (p.c.f.), which exhibit structural strengths of as much as 3000 pounds per square inch (p.s.i.). Note that strengths of 3000 to 4200 p.s.i. are contemplated by the inventive cementitious concrete mixture, which, as hereinbefore described, may comprise scoria, or other known aggregate.

The present invention further contemplates that the concrete composite structural bars 12 are cast using a mold process as would be known in the art. The bars form at least a portion of a containerization support system 10 for use in metal cutting processes, as previously described, and are made from a mixture of lightweight cementitious material and metal based material, cooperating together to render the bar 12 structurally strong and resistant to wear.

Referring again to FIG. 1, the containerization support structure includes a flooring structure 40 and a plurality of concrete composite structural bars 12 positioned within the flooring structure 40. The bars 12 may extend longitudinally and are generally horizontally disposed within the flooring structure 40. Additionally, the bars may be removable from the flooring structure 40 for cleaning or replacement.

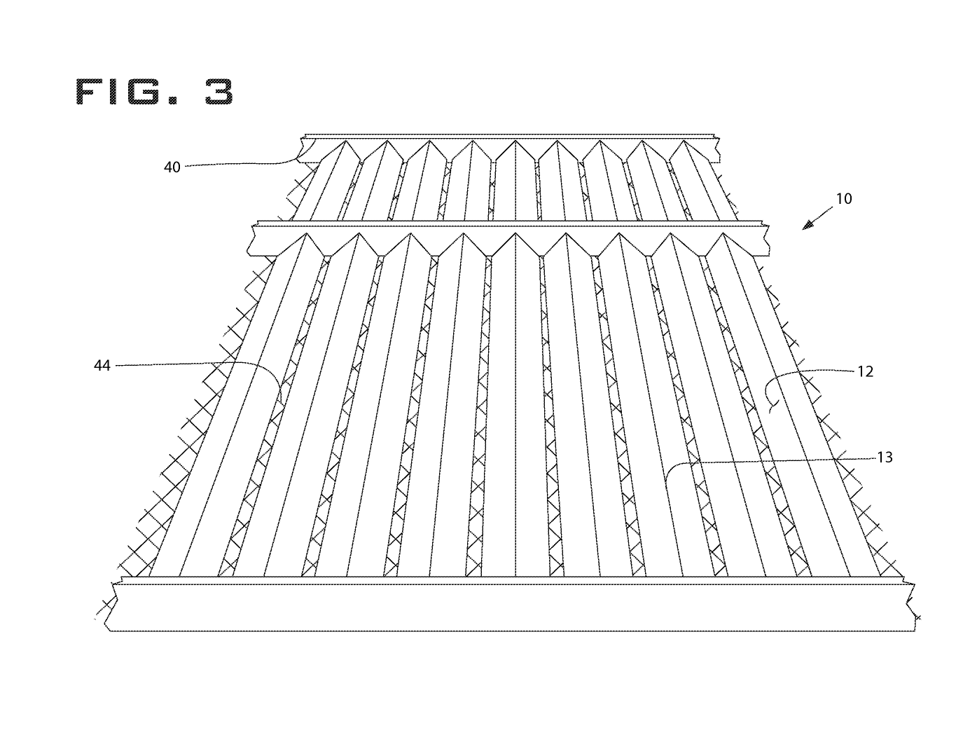

The flooring structure 40, as shown in FIG. 3, may include a bottom piece 44 fabricated from metal or other suitable material. The bottom piece 44 would typically cover the entire containerization structure and may optionally be perforated. The flooring structure 40 may include a plurality of longitudinally extending metal carriers 22 adapted for receiving the plurality of concrete composite structural bars 12.

The metal carriers 22 may be affixed to the bottom piece 44 and may run the full length of the containerization support system 10. The metal carriers 22 may be aligned generally perpendicularly to the bottom piece 44. The metal carriers 22 would optimally be shaped to receive or carry the concrete composite structural bars 12 and may have adaptive tabs (not shown) to temporarily secure the bars 12. The flooring structure may also have one or two pairs of sidewalls 26 parallel and opposite each other, at the outer edges of the flooring structure 40. Additionally, the bars 12 may be removed from the carriers for cleaning or replacement.

While aspects of the present disclosure have been particularly shown and described with reference to the embodiments above, it will be understood by those skilled in the art that various additional embodiments may be contemplated without departing from the spirit and scope of the present disclosure as determined based upon the claims below and any equivalents thereof.

### INDUSTRIAL APPLICABILITY

The disclosed containerization system finds potential application in any situation where plasma or machine cutting occurs where it is desirous to control disposition of scoria, dross or other metal by-product is released. The disclosed containerization support system finds particular applicability in large plant and manufacturing facilities. One skilled in the art will recognize that the disclosed system could be utilized in relation to other cutting systems that may or may not be associated with plasma arc cutting machines.

The disclosed method of implementing a reusable containerization system for collecting metal by-product during a metal cutting operation includes the steps of positioning concrete composite structural bars within a flooring structure, where the flooring structure includes a plurality of longitudinally extending metal carriers positioned to house the bars; performing a metal cutting operation; collecting the metal by-product on the concrete composite structural bars; removing the bars; cleaning metal by-product from the bars; and returning the concrete composite structural bars to the metal carriers.

The method of implementing a reusable containerization system for collecting metal by-product during a metal cutting operation, may further include the steps of replacing the concrete composite structural bars after structural integrity is comprised; and returning or adding new replacement concrete composite structural bars onto the metal carriers. Further, this method contemplates manufacturing the concrete structural bars through casting, molding or related process as is known in the art.

It will be appreciated that the foregoing description provides examples of a novel containerization system for use with machine cutting processes. However, it is contemplated that other implementations of the disclosure may differ in detail from the foregoing examples, as would occur to those skilled in the art. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely, unless otherwise indicated.

Recitation of ranges of values or dimensions herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. Accordingly, this disclosure includes all modifications and equivalents of subject matter recited in the claims appended hereto as permitted by applicable law. Moreover, any combination of the above-described elements in all possible variations thereof is encompassed by the disclosure unless otherwise indicated herein or otherwise clearly contradicted by context.

Other aspects, objects, and advantages of the present disclosure can be obtained from a study of the drawings, disclosure and the appended claims.

What is claimed is:

1. A containerization support structure for use in metal cutting processes comprising:
a flooring structure; and
a plurality of concrete composite structural bars positioned within said flooring structure.

2. The containerization support structure of claim 1, wherein said plurality of concrete composite structural bars extend longitudinally.

3. The containerization support structure of claim 1, wherein said plurality of concrete composite structural bars are horizontally disposed.

4. The containerization support structure of claim 1, wherein said plurality of concrete composite structural bars are removably positioned within said flooring structure.

5. The containerization support structure of claim 1, wherein the cross section of said concrete structural bars is diamond shaped.

6. The containerization support structure of claim 5, wherein the cross section of said concrete structural bars is rectangular.

7. The containerization support structure of claim 5, wherein the cross section of said concrete structural bars is circular.

8. The containerization support structure of claim 1, wherein said plurality of concrete composite structural bars are a strongly compressed densified mixture of a cementitious and metal material adapted to withstand repeated contact with metal byproducts from said metal cutting process.

9. The containerization support structure of claim 1, wherein said plurality of concrete composite structural bars are fabricated from a cementitious material mixture with said metal cutting by-product.

10. The containerization support structure of claim 9, wherein said plurality of concrete composite structural bars are fabricated from a cementitious material mixture with scoria.

11. The containerization support structure of claim 9, wherein said plurality of concrete composite structural bars are fabricated from a cementitious material mixture with slag.

12. The containerization support structure of claim 1, wherein said flooring structure includes a bottom piece encompassing the entire flooring structure.

13. The containerization support structure of claim 1, wherein said bottom piece is made of metal.

14. The containerization support structure of claim 1, wherein said bottom piece is perforated.

15. The containerization support structure of claim 1, further comprising a pair of parallel facing sidewall pieces on opposite ends of the containerization support structure.

16. The containerization support structure of claim 15 wherein said frame includes two additional parallel facing sidewall pieces adjacent the pair of sidewall pieces on opposite ends of the containerization structure, forming a box shaped structure.

17. The containerization support structure of claim 1, wherein said flooring structure includes a plurality of longitudinally extending metal carriers adapted for receiving the plurality of concrete composite structural bars.

18. The containerization support structure of claim 17, wherein the metal carriers are generally perpendicular to said bottom piece

19. A method of implementing a reusable containerization system for collecting metal by-product during a metal cutting operation, the steps comprising: positioning concrete composite structural bars within a flooring structure, said flooring structure including a plurality of longitudinally extending metal carriers positioned to house said bars; performing a metal cutting operation; collecting the metal by-product on said concrete composite structural bars; removing said bars; cleaning metal by-product from said bars; and returning said concrete composite structural bars to said metal carriers.

20. The method of implementing a reusable containerization system for collecting metal by-product during a metal cutting operation of claim 19, the steps further comprising:
replacing concrete composite structural bars after structural integrity comprised; returning new concrete composite structural bars onto said metal carriers.

21. A cast concrete composite structural bar for forming at least a portion of a containerization support structure for use in metal cutting processes, comprising a mixture of lightweight cementitious material and metal based material, the metal based material being of a type such that the cementitious material and the metal based material cooperate together to render the bar structurally strong and resistant to wear.

22. A metal cutting system for cutting a workpiece comprising: a cutting torch having a nozzle and an electrode for producing a plasma arc in accordance with a cutting current supplied to the electrode, said cutting torch being movably disposed relative to the workpiece and cutting the workpiece with the plasma arc; power supply means for supplying the cutting current to the electrode of said cutting torch; moving means for moving said cutting torch relative to the workpiece; storage means for storing cut machining data; drive control means for numerically controlling said moving means in accordance with the cut machining data read out of said storage means, said moving means moving said cutting torch at a speed relative to the workpiece; a flooring structure; and, a plurality of longitudinally extending concrete composite structural bars, said flooring structure including generally perpendicular disposed metal carriers adapted for receiving said bars.
